(19) United States
(12) Patent Application Publication
(10) Pub. No.: US 2026/0278873 A1
(43) Pub. Date: Sep. 17, 2026

(54) UNIFIED CONSTRAINT SYSTEMS FOR VECTOR GRAPHICS

(71) Applicant: Adobe Inc., San Jose, CA (US)

(72) Inventors: Rishav Agarwal, Howrah (IN); Praveen Kumar Dhanuka, Howrah (IN); Arushi Jain, Delhi (IN); Ronak Mehta, UDAIPUR (IN)

(21) Appl. No.: 19/081,371

(22) Filed: Mar. 17, 2025

(51) Int. Cl. G06T 11/60

(52) U.S. Cl. CPC G06T 11/60; G06T 2200/24

(57) ABSTRACT

The present disclosure relates to systems, non-transitory computer-readable media, and methods for generating a modified vector graphic for display by propagating a constraint entity. In one or more embodiments, the disclosed systems determine a constraint entity comprising a constraint type defining execution logic for the constraint entity and further comprising a set of constraint objects of the constraint type for a vector graphic. The disclosed systems detect a client device interaction modifying a constraint object within the set of constraint objects defined by the constraint entity. The disclosed systems generate a modified constraint entity in response to the interaction modifying the constraint object by updating the constraint entity according to the constraint type to reflect corresponding modifications to one or more related constraint objects within the set of constraint objects. The disclosed systems generate a modified vector graphic depicting the modified constraint entity for display on the client device.

### BACKGROUND

A key challenge in generating digital designs is contingent manipulation of vector graphics—where editing one graphic impacts other graphics in a design—while preserving underlying rules. Reconfiguring vector graphics contingent on their relationships to one another and/or to other design elements requires dynamically adjusting the vector graphics in response to manipulation of one vector graphic in the group. To modify vector graphics, many existing systems iteratively update constraints which define custom limitations or mathematical rules for design objects or graphics, governing aspects such as size, inter-object spacing, alignment, and relative positioning. Such iterative modification requires extensive user editing of each graphical design element. Although some approaches offer a measure of automatic adjustment of vector graphics, constraint modeling in such approaches is limited to specific environments and not extensible to third-party applications. Thus, despite advancements in modifying vector graphics, existing systems exhibit a number of drawbacks or disadvantages in constraint modeling for propagating contingent modifications to vector graphics.

### SUMMARY

This disclosure describes one or more embodiments of systems, methods, and non-transitory computer readable media that solve one or more of the foregoing or other problems in the art through a unified constraint system to manage constraints guiding modification of vector graphics. In some embodiments, the disclosed systems utilize a unique definition for a constraint entity to apply contingent manipulations to vector graphics. For instance, the disclosed systems define a constraint entity as a three-part construct, including: 1) a constraint type that uniquely identifies a rule set for the constraint entity, 2) a set of one or more constraint objects affected by the rule set of the constraint type, and 3) constraint data defining a map of parameters for execution logic corresponding to a constraint type. In some embodiments, the disclosed systems leverage an observer-listener mechanism for constraint entities to apply contingent manipulations to objects in an entity while also following ordering rules for how to apply the manipulations. In some embodiments, the disclosed systems utilize constraint states as part of propagating modifications. In some instances, the disclosed systems further implement a decoupled constraint framework and a unique constraint streaming mechanism to maintain and apply constraints with persistent identities.

### BRIEF DESCRIPTION OF THE DRAWINGS

The disclosure describes one or more embodiments of the invention with additional specificity and detail by referencing the accompanying figures. The following paragraphs briefly describe those figures.

FIG. 1 illustrates a diagram of an environment in which a constraint modification system operates in accordance with one or more embodiments.

FIG. 2 illustrates a diagram of an overview of the constraint modification system modifies a constraint to generate a modified vector graphic in accordance with one or more embodiments.

FIG. 3 illustrates a diagram of comparing two constraints to determine an execution sequence accordance with one or more embodiments.

FIGS. 4A-C illustrate diagrams of defining constraint states in accordance with one or more embodiments.

FIG. 5 illustrates a diagram of a constraint executor plugin architecture in accordance with one or more embodiments.

FIGS. 6A-6B illustrate diagrams of generating a constraint object label to map constraints to vector designs across multiple client sessions in accordance with one or more embodiments.

FIGS. 7A-7B illustrate example images of updating a vector graphic according to modified constraints in accordance with one or more embodiments.

FIG. 8 illustrates an example schematic diagram of a constraint modification system in accordance with one or more embodiments.

FIG. 9 illustrates an example flowchart of a series of acts for generating a modified vector graphic by modifying constraints in accordance with one or more embodiments.

FIG. 10 illustrates a block diagram of an example computing device in accordance with one or more embodiments.

### DETAILED DESCRIPTION

This disclosure describes one or more embodiments of a constraint modification system that generates modified vector graphics based on a client device interaction. For example, the constraint modification system determines one or more constraint entities for a vector graphic, with each constraint entity including a constraint type, a set of constraint objects, and a constraint data map. In some embodiments, the constraint modification system detects a client device interaction with an object within the set of constraint objects and then modifies the corresponding constraint entity (e.g., by applying contingent modifications to the remaining objects in the entity). In one or more embodiments, the constraint modification system generates a modified vector graphic depicting the modified constraint entity. In some embodiments, the constraint modification system determines an execution order for multiple constraint entities by comparing the hierarchical relationship of the corresponding sets of constraint objects. As part of an overarching framework to support this new definition of constraint entities across various systems, in one or more embodiments, the constraint modification system utilizes a decoupled constraint executor plugin architecture to generate modified constraint entities. In some embodiments, the constraint modification system further determines and modifies a constraint state for the constraint entity. In one or more embodiments, the constraint modification system generates a constraint object key to maintain the constraint entity across multiple client device sessions.

As noted, in one or more embodiments, the constraint modification system determines a constraint entity for a vector graphic. For example, the constraint modification system defines a constraint type, a set of constraint objects, and a constraint data map for the constraint entity. In one or more embodiments, the constraint type defines the execution logic, or the rule set of the constraint, such as rules for keeping objects on a line or adjusting the arrangement of a set of objects to preserve a certain shape (e.g., a circle) based on removing an object from the set of objects. In some embodiments, the set of constraint objects refers to a set of digital design elements within a vector graphic connected by the same constraint entity and which are contingent on modifications to other objects in the constraint entity (e.g., objects on a line or objects arranged in a certain shape). In one or more embodiments, the constraint data map holds constraint specific parameters used to execute the constraint entity. In some embodiments, the constraint modification system leverages an observational relationship to a set of art objects to identify modifications to an object in the set of art objects. In one or more embodiments, the constraint modification system propagates the modification to the rest of the art objects according to the constraint type based on observing the modifications.

In one or more embodiments, the constraint modification system defines a logical order in which to execute a given set of constraint entities. For example, the constraint modification system uses a constraint comparator to enforce the logical order of the execution of constraints to avoid premature execution. In one or more embodiments, the constraint modification system determines the logical order by comparing objects within a set of constraint objects to determine a hierarchical relationship among the set of constraint objects. Based on this hierarchical relationship, the constraint modification system compares constraint entities to determine priority among the multiple constraint entities to generate an execution sequence defining the logical order of execution.

In one or more embodiments, the constraint modification system utilizes a constraint manager to manage multiple constraint entities in a vector graphic or a design. For example, the constraint modification system utilizes the constraint manager to communicate with other vector graphic workflows and to save the constraint entities for use in a second client device session. In one or more embodiments, the constraint modification system utilizes a constraint executor as a separate user interface plugin architecture that interfaces with the constraint manager to propagate the execution of a constraint entity. In some embodiments, the constraint modification system notifies the constraint executor of a constraint entity modification, and the constraint executor propagates the constraint entity to update the vector graphic.

In one or more embodiments, the constraint modification system defines constraint states pertaining to constraint entities. For example, each constraint entity is set to one of five constraint states based on its execution status: 1) a clean state (a default state indicating that the constraint entity is not needing execution), 2) a dirty state (indicating that the constraint entity is awaiting execution), 3) a suspended state (indicating that the constraint entity does not trigger execution based on changes to the corresponding set of constraint objects), 4) a hibernate state (indicating that changes to the set of constraint objects will not re-trigger execution of the constraint entity), or 5) an execution state (indicating that the constraint entity is currently executing). In one or more embodiments, the constraint modification system updates the constraint state of multiple constraint entities based on an execution order determined for the constraint entities (e.g., updating the constraint state of all constraint entities remaining to be executed in the execution order to a dirty state).

In one or more embodiments, the constraint modification system represents each constraint entity in document metadata, enabling efficient storage and reading when a file with constraint entities is opened. For example, the constraint modification system implements a persistent identify framework that generates a constraint object label identifying each object in a set of constraint objects (e.g., a random Unicode string). In one or more embodiments, the constraint modification system utilizes a constraint object key to map the constraint object labels to a vector design key (e.g., a Persistent ID included with the document), matching the constraint entity to the set of constraint objects in a second client device session. In some embodiments, the constraint modification system generates an un-ordered map of the vector designed key mapped to the constraint object labels, identifying the objects constrained by the constraint entity.

As suggested above, existing systems exhibit drawbacks or deficiencies in updating vector designs based on client device interactions with elements of the vector design. Although existing systems update vector designs to an extent, such systems have a number of problems or inadequacies in relation to flexibility and accuracy. To illustrate, existing systems either have no constraint framework or implement a constraint framework that is not extensible and which requires manual, iterative modifications to objects. Indeed, existing constraint definitions are often rigidly fixed to specific environments (which are sometimes limited to a fixed set of constraints) and are therefore not extensible to third-party plugins (for registering custom constraints). Neither are existing constraints adaptable to apply contingent modifications to objects in a shared sense, instead requiring individual, iterative (and often manual) updates to each object in a constraint.

Due at least in part to their inflexible natures, many existing systems are inaccurate. For instance, because certain existing systems rely on iterative (and manual) updates of individual objects in a constraint, such systems are prone to error where even small inconsistencies in applying each of the modifications to the objects sometimes result in incorrect and even jarring visualizations. Such errors are only more prevalent and more apparent when constraints contain larger numbers of objects, as propagating the modifications in this iterative manner becomes more onerous. Not only is the iterative nature of existing constraint definitions prone to error and inaccuracy, but it also results in high latency and slow operation times, preventing interactive (e.g., real-time or near real-time) application of constraint-level modifications during the design process.

As suggested, embodiments of the constraint modification system provide several advantages and benefits over existing systems. For example, embodiments of the constraint modification system improve flexibility and accuracy over prior systems. In some embodiments, the constraint modification system improves flexibility by implementing an extensible constraint framework adaptable to other environments and third-party plugins and by automatically propagating constraint execution for contingent modifications. Indeed, through the new constraint construct (e.g., the constraint entity), the constraint modification system is able to pass constraints across multiple graphical design environments (e.g., via third-party plugins) using a novel decoupled framework for constraint execution and communication. Additionally, using the new composition of a constraint entity, the constraint modification system flexibly adapts objects within a constraint entity to align with modifications made to single objects within the constraint. For instance, the constraint modification system detects and applies contingent modifications automatically (e.g., without user input) and based on a constraint entity execution order, circumventing the need for iterative, individual updates to each constrained object.

The constraint modification system also improves accuracy due to its more flexible nature. By automatically propagating constraints, the constraint modification system automatically updates constrained objects in a uniform manner, leading to accurate and uniform vector designs. Even for large sets of constrained objects, the constraint modification system propagates modifications to objects across multiple constraints in response to changes to a single object in a set, leading to accurate execution and uniformity of constraints. Not only is the constraint execution more accurate than prior systems reliant on iterative, manual propagation across objects or graphics, but the constraint modification system further executes constraints in a real-time, interactive fashion for on-the-fly editing and manipulation. Indeed, because to the makeup of the constraint entity, the ordering approach, and the constraint states described herein, embodiments of the constraint modification system propagate modifications at the constraint level (e.g., for a constraint entity including multiple objects) in real-time, permitting interactive interactions with vector graphics in the design with little or no wait time.

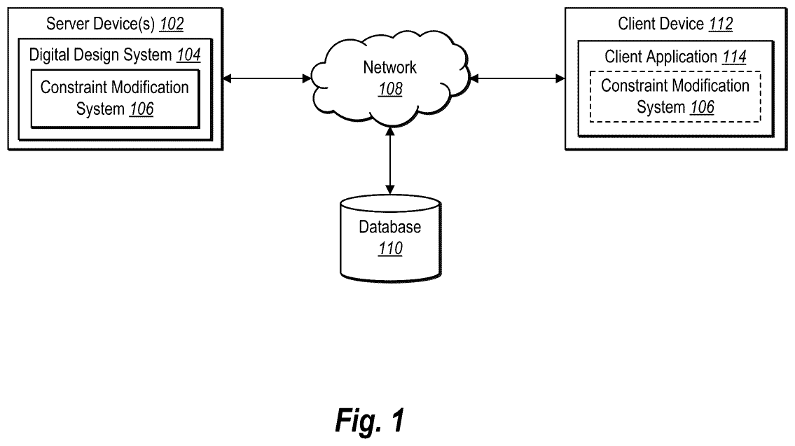

Additional detail regarding the constraint modification system 106 will now be provided with reference to the figures. For example, FIG. 1 illustrates a schematic diagram of an example system environment for implementing a constraint modification system 106 in accordance with one or more embodiments. An overview of the constraint modification system 106 is described in relation to FIG. 1. Thereafter, a more detailed description of the components and processes of the constraint modification system 106 is provided in relation to the subsequent figures.

As shown, the environment includes server device(s) 102, a database 110, a network 108, and a client device 112. Each of the components of the environment communicate via the network 108, and the network 108 is any suitable network over which computing devices communicate.

As mentioned, the environment includes a client device 112. The client device 112 is one of a variety of computing devices, including a smartphone, a tablet, a smart television, a desktop computer, a laptop computer, a virtual reality device, an augmented reality device, or another computing device. The client device 112 communicates with the server device(s) 102 via the network 108. For example, the client device 112 provides information to server device(s) 102 indicating client device interactions (e.g., defining a constraint entity, interacting with a digital object from a set of constraint objects) and receives information from the server device(s) 102 (e.g., a modified vector graphic). Thus, in some cases, the constraint modification system 106 on the server device(s) 102 provides and receives information based on client device interaction via the client device 112.

As shown in FIG. 1, the client device 112 includes a client application 114. In particular, the client application 114 is a web application, a native application installed on the client device 112 (e.g., a mobile application, a desktop application, etc.), or a cloud-based application where all or part of the functionality is performed by the server device(s) 102. Based on instructions from the client application 114, the client device 112 presents or displays information to a user. For example, the client device 112 presents modified vector graphics according to execution of a constraint entity and/or display data generated and provided by the constraint modification system 106 and interpreted by a processor (e.g., a graphics processor) and/or renderer on the client device 112. In some cases, the client device 112 includes a version of the constraint modification system 106 (e.g., as a downloaded and/or installed application where all or part of the functionality is performed at the client device 112).

In certain cases, the client device 112 includes all or part of the constraint modification system 106. For example, the client device 112 generates, obtains (e.g., downloads), or utilizes one or more aspects of the constraint modification system 106 from the server device(s) 102. Indeed, in some implementations, as illustrated in FIG. 1, the constraint modification system 106 is located in whole or in part on the client device 112. For example, the constraint modification system 106 includes a web hosting application that allows the client device 112 to interact with the server device(s) 102. To illustrate, in one or more implementations, the client device 112 accesses a web page supported and/or hosted by the server device(s) 102.

As illustrated in FIG. 1, the environment includes the server device(s) 102. The server device(s) 102 generates, tracks, stores, processes, receives, and transmits electronic data, such as vector graphics, constraint entities, document metadata, and constraint executor information. The server device(s) 102, for example, receives data from the client device 112 in the form of a client device interaction (e.g., altering an object constrained by a constraint entity) to generate a modified vector graphic according to propagating the constraint entity across the vector graphic. In response, the server device(s) 102 transmits data to the client device 112 to display or present a modified vector graphic based on the client device interaction.

In some embodiments, the server device(s) 102 communicates with the client device 112 to transmit and/or receive data via the network 108, including client device interactions, digital designs, and/or other data. In some embodiments, the server device(s) 102 comprises a distributed server where the server device(s) 102 includes a number of server devices distributed across the network 108 and located in different physical locations. The server device(s) 102 comprise a content server, an application server, a communication server, a content editing server, a web-hosting server, a multidimensional server, and/or a machine learning server. The server device(s) 102 further access and utilize the database 110 to store and retrieve information such as vector graphics, constraint entities, and constraint executors.

As further shown in FIG. 1, the server device(s) 102 also includes the constraint modification system 106 as part of a digital design system 104. For example, in one or more implementations, the digital design system 104 is able to store, generate, modify, edit, enhance, provide, distribute, and/or share digital designs. For example, the digital design system 104 provides tools for the client device 112, via the client application 114, to generate modified vector graphics by propagating one or more constraint entities. In one or more embodiments, the server device(s) 102 includes all, or a portion of, the constraint modification system 106. For example, the constraint modification system 106 operates on the server device(s) 102 to generate modified vector graphics.

In one or more embodiments, the client device 112 and the server device(s) 102 work together to implement the constraint modification system 106. For example, in some embodiments, the client device 112 defines a constraint entity for a vector graphic and modifies a constraint object relating to the constraint entity, the server device(s) 102 propagates the constraint entity to generate a modified vector graphic, and the client device 112 presents the modified vector graphic. Furthermore, in some implementations, the client device 112 assists in generating the modified vector graphic.

Although FIG. 1 illustrates a particular arrangement of the environment, in some embodiments, the environment has a different arrangement of components and/or may have a different number or set of components altogether. For instance, as mentioned, the constraint modification system 106 is implemented by (e.g., located entirely or in part on) the client device 112. In addition, in one or more embodiments, the client device 112 communicates directly with the constraint modification system 106, bypassing the network 108.

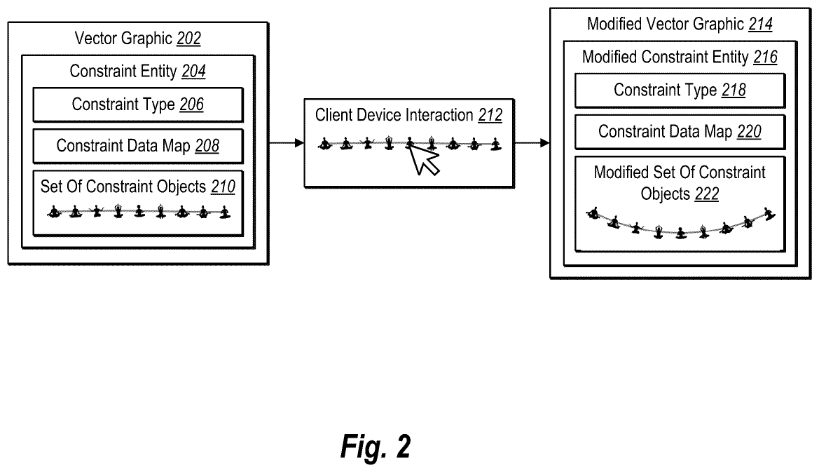

As mentioned, in one or more embodiments, the constraint modification system 106 generates a modified vector graphic. FIG. 2 illustrates an overview of generating a modified vector graphic by modifying a constraint entity in response to a client device interaction in accordance with one or more embodiments. Additional detail regarding the various acts and processes mentioned with respect to FIG. 2 is provided thereafter with reference to subsequent figures.

As illustrated in FIG. 2, the constraint modification system 106 processes a vector graphic 202 to determine a constraint entity 204. In particular, the constraint modification system 106 processes the vector graphic 202 as a portion of a larger digital design (e.g., a shape or text element of a digital design). In one or more embodiments, the constraint modification system 106 determines the constraint entity 204 based on a client device selection or definition of a constraint, such as by selecting objects to include together in a constraint. In one or more embodiments, the constraint modification system 106 generates the constraint entity 204 as a logical entity that observes interactions with a set of constrained objects (e.g., the set of constraint objects 210). For instance, the constraint modification system 106 receives one or more device inputs defining constraint rules or logic for objects in a constraint entity. In some cases, the constraint modification system 106 analyzes a set of objects within a constraint entity to determine or extract rules based on attributes such as object sizing, spacing, relative location to each other and/or to another object in a design, color, and/or other attributes. In one or more embodiments, the constraint modification system 106 defines a constraint according to the following formula:

$$C = ( U , θ , T )$$

where C represents the constraint entity 204, U represents the set of constraint objects 210, 0 represents an un-ordered map (e.g., the constraint data map 208) holding constraint-specific parameters corresponding to a constraint type, and T represents the constraint type 206.

In some cases, a constraint entity refers to a logical entity that leverages an observer-listener mechanism to enforce limitations or rules to ensure consistency among constrained objects in a digital design. For example, a constraint entity includes a constraint type that defines a specific ruleset to be executed, a list of objects which it observes, and an unordered data map. For example, a change to one of the observed objects causes the constraint modification system 106 to execute the constraint ruleset (e.g., that all the observed objects stay on a line) of the constraint type by accessing the data map of the constraint entity.

As further illustrated in FIG. 2, the constraint modification system 106 generates a constraint type 206 as part of the constraint entity 204. In particular, the constraint modification system 106 generates the constraint type 206 to serve as a logical ruleset governing the implementation of the constraint entity 204. For example, the constraint modification system 106 defines the constraint type 206 as a path-based relational constraint, wherein the constraint modification system 106 uses the constraint type 206 to maintain an arrangement of multiple objects (e.g., the set of constraint objects 210) along a line or path. Alternatively, the constraint modification system 106 defines the constraint type 206 as a dimensional constraint, wherein the constraint modification system 106 uses the constraint type 206 to update object dimensions and geometry. In some embodiments, the constraint modification system 106 defines the constraint type 206 as an info-graphical visual representation, wherein the constraint modification system 106 uses the constraint type 206 to arrange multiple data text objects against a bar-graph or a circular arc.

As further illustrated in FIG. 2, the constraint modification system 106 generates a constraint data map 208 as part of the constraint entity 204. In particular, the constraint modification system 106 generates the constraint data map 208 as a dictionary for data related to the constraint entity 204. In one or more embodiments, the constraint modification system 106 utilizes the constraint data map 208 to represent the constraint entity 204 data as a templatized unordered map holding key-value pairs specific to the constraint type 206. For example, the constraint modification system 106, for a constraint type 206 in the form of a path-based relational constraint, generates the constraint data map 208 to include keys such as inter-object spacing or common rotation applied on constrained objects (e.g., the set of constraint objects 210), where the corresponding values (of the key-value pairs) are the amounts, magnitudes, or quantities of the keys (e.g., the inter-object spacing and the common rotation).

As further illustrated in FIG. 2, the constraint modification system 106 identifies a set of constraint objects 210. In particular, the constraint modification system 106 identifies the set of constraint objects 210 as those objects observed by, or included within, the constraint entity 204. In one or more embodiments, the constraint modification system 106 identifies the set of constraint objects 210 based on a client device selection of one or more objects within a digital design and/or an indication of the constraint type 206 and/or the constraint data map 208. In some embodiments, the constraint modification system 106 stores the set of constraint objects 210 as part of the constraint entity 204 as a list of objects including information such as object geometry and locations. In one or more embodiments, the constraint modification system 106 recognizes the set of constraint objects 210 as part of a larger vector graphic (e.g., items on a line, a shape). In one or more embodiments, the constraint modification system 106 represents the set of constraint objects 210 according to the following formula:

$$U = ( {u}_{1} , {u}_{2} , … , {u}_{n} ) \vert {u}_{i} ⊥ {u}_{j} ∀ ( i , j ) ∈ [ 1 , n ]$$

where U represents a set of constrained objects (e.g., the set of constraint objects 210), u represents an object within U, and uᵢ⊥uⱼ∀(i,j)∈[1, n] enforces that each object within the set of constrained objects be mutually independent of one another (e.g., non-overlapping). The constraint modification system 106 thus defines parameters within the constraint data map 208 (e.g., θ) as agnostic to the set of constraint objects 210 (e.g., U).

As further illustrated in FIG. 2, the constraint modification system 106 detects a client device interaction 212 with an object in the set of constraint objects 210. In particular, the constraint modification system 106 leverages the observer relationship of the constraint entity 204 to detect changes in the set of constraint objects 210 caused by the client device interaction 212. In one or more embodiments, the constraint modification system 106 detects the client device interaction 212 based on alterations to one or more objects in the set of constraint objects 210, such as transformations to the dimensions or rotation or movement of an object in the set of constraint objects 210. As shown, the constraint modification system 106 detects a click-and-drag interaction to curve the line on which the depicted figures are placed.

As further illustrated in FIG. 2, the constraint modification system 106 generates a modified vector graphic 214 based on the client device interaction 212. In particular, the constraint modification system 106 generates the modified vector graphic 214 by updating the constraint entity 204 to generate a modified constraint entity 216. In one or more embodiments, the constraint modification system 106 updates the constraint entity 204 by propagating the alterations made in the client device interaction 212 across the set of constraint objects 210 to generate a modified set of constraint objects 222 in accordance with the logical ruleset defined in the constraint entity 204 (e.g., as set forth in the constraint data map 208).

For example, the constraint modification system 106 generates the modified constraint entity 216 by modifying the set of constraint objects 210 to conform with the client device interaction 212, such as by transforming the path connecting the objects in the set of constraint objects 210 and altering the rotation of the objects in the set of constraint objects 210 to match the alteration caused by the client device interaction 212 while conforming with the constraint type 218 (e.g., a path-based relational constraint). In one or more embodiments, the constraint modification system 106 generates the modified set of constraint objects 222 by applying the logical ruleset defined by the constraint type 218 according to the keys stored in the constraint data map 220 to the set of constraint objects 210. In some embodiments, the constraint modification system 106 generates the modified set of constraint objects 222 automatically (and in interactive fashion without interruption to the editing process to wait for modifications to apply) by propagating the modified constraint entity 216 in real time.

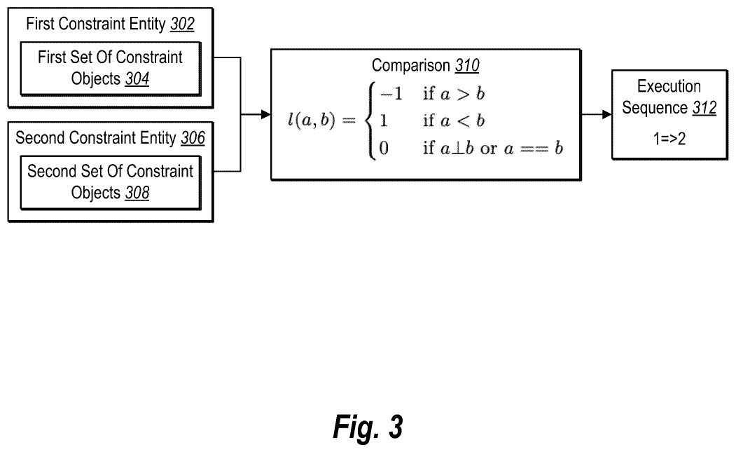

As mentioned, in one or more embodiments, the constraint modification system 106 compares multiple constraint entities to determine an execution sequence or an order for executing the multiple constraint entities. FIG. 3 illustrates a diagram depicting comparing two constraint entities to determine an execution sequence in which to execute the two constraint entities in accordance with one or more embodiments.

As illustrated in FIG. 3, the constraint modification system 106 determines a first constraint entity 302 corresponding to a first set of constraint objects 304 and a second constraint entity 306 corresponding to a second set of constraint objects 308. In particular, the constraint modification system 106 determines the first constraint entity 302 in relation to the first set of constraint objects 304 and the second constraint entity 306 in relation to the second set of constraint objects. In one or more embodiments, the first set of constraint objects 304 and the second set of constraint objects 308 correspond to different sets of constrained objects and do not share any design objects. In some embodiments, the first set of constraint objects 304 and the second set of constraint objects 308 share one or more constrained objects. In certain embodiments, the first set of constraint objects 304 and the second set of constraint objects 308 correspond to the same set of constrained objects. In one or more examples, the second set of constraint objects 308 includes a group of objects including the first set of constraint objects 304 in part or in entirety, resulting in the first constraint entity 302 being nested in the second constraint entity 306.

As further illustrated in FIG. 3, the constraint modification system 106 performs a comparison 310 between the first constraint entity 302 and the second constraint entity 306. In one or more embodiments, the constraint modification system 106 compares the first set of constraint objects 304 and the second set of constraint objects 308 to determine whether one of the sets of constraint objects is the ancestor of the other, determining a hierarchical relationship between the first set of constraint objects 304 and the second set of constraint objects 308. In some embodiments, the constraint modification system 106 defines the hierarchical relationship (and therefore the ordering or the execution sequence) between the first set of constraint objects 304 and the second set of constraint objects 308 according to the following formula:

$$ψ ( {U}_{a} , {U}_{b} ) = {\sum }_{i = 1} {\sum }_{j = 1} l ( {u}_{i}^{a} , {u}_{j}^{b} )$$

where Uₐ represents a first set of constrained objects (e.g., the first set of constraint objects 304), U_{b} represents a second set of constrained objects (e.g., the second set of constraint objects 308), l represents a less-than function,

$${u}_{i}^{a}$$

represents an object within the first set of constrained objects, and

$${u}_{j}^{b}$$

represents an object within the second set of constrained objects.

Further, the constraint modification system 106 performs the comparison 310 by using a comparison operator to define an ordering (e.g., the execution sequence 312) for the first constraint entity 302 and the second constraint entity 306 based on the hierarchical relationship determined between the first set of constraint objects 304 and the second set of constraint objects 308. In some embodiments, the constraint modification system 106 performs the comparison 310 according to the following formula:

$$l ( {C}_{a} , {C}_{b} ) = \{ \begin{matrix}- 1 & if {T}_{a} < {T}_{b} or ψ ( {U}_{a} , {U}_{b} ) > 0 \\ 1 & if {T}_{a} > {T}_{b} or ψ ( {U}_{a} , {U}_{b} ) < 0 \\ 0 & otherwise\end{matrix}$$

where Cₐ represents a first constraint entity (e.g., the first constraint entity 302), C_{b} represents a second constraint entity (e.g., the second constraint entity 306), Tₐ represents a first constraint entity type, and T_{b} represents a second constraint entity type.

For example, given two constraint entities (e.g., the first constraint entity 302 and the second constraint entity 306) defined as C₁ and C₂ respectively, the constraint modification system 106 determines that the constraint objects constrained by C₁ (e.g., the first set of constraint objects 304) are ancestors of at least some constraint object constrained by C₂ (e.g., the second set of constraint objects 308) when U₁>U₂ as ψ(U₁, U₂)=−|U₂|. As another example, if U₁ and U₂ contain constraint objects that descend from groups of constraint objects G₁ and G₂, respectively, and if G₁ and G₂ are mutually independent, then the constraint modification system 106 determines that ψ(U₁, U₂)=0, indicating the two are independent.

Additionally, the constraint modification system 106 performs the comparison 310 to determine whether (all or some of the objects within) the first constraint entity 302 is/are nested within the second constraint entity 306 as part of determining the execution sequence 312. For example, the constraint modification system 106 defines constraints C₁, C₂, and C₃ in relation to sets of constraint objects U₁, U₂, and U₃. Further, the constraint modification system 106 determines constraint objects U₁, U₂, and U₃ are inside groups G₁, G₂, and G₃, respectively. Additionally, the constraint modification system 106 defines another constraint C₄ on top of groups G₁, G₂, and G₃. Thus, the constraint modification system 106 utilizes the comparison 310 to determine that:

$$l ( {C}_{i} {C}_{4} ) = 1 ∀ i ∈ 1 , 2 , 3$$

defining that the constraints C₁, C₂, and C₃ are executed before the constraint C₄.

Further, the constraint modification system 106 determines whether there is dependency between two constraints. For instance, given two constraints C₁ and C₂ with the constraint objects within C₁ as ancestor of one or more of the constraint objects within C₂, the constraint modification system 106 determines this relationship as U₁>U₂ as ψ(U₁, U₂)=−|U₂|. Based on this determination, the constraint modification system 106 further determines that there is an edge from U₂ to U₁ and that therefore the constraint modification system 106 executes C₂ before C₁.

In an alternative case, the constraint modification system 106 determines that two constraints are mutually independent. Given that U₁ and U₂ contain mutually independent objects such that ψ(U₁, U₂)=0, the constraint modification system 106 determines that there is no edge between C₂ and C₁ and accordingly no dependence between the constraint entities.

As further illustrated in FIG. 3, the constraint modification system 106 determines an execution sequence 312 from the comparison 310. In one or more embodiments, the constraint modification system 106 determines the execution sequence 312 to indicate an order of execution for the first constraint entity 302 and the second constraint entity 306 (e.g., executing the first constraint entity 302 before the second constraint entity). In one or more embodiments, the constraint modification system 106 enforces the execution sequence 312 to logically enforce the first constraint entity 302 and the second constraint entity 306 to avoid premature executions and unwanted visual phenomena present within a vector graphic (e.g., the modified vector graphic 214 from FIG. 2). In some embodiments, the constraint modification system 106 determines that a child constraint entity descends from an ancestor constraint entity and executes the child constraint entity before the ancestor constraint entity.

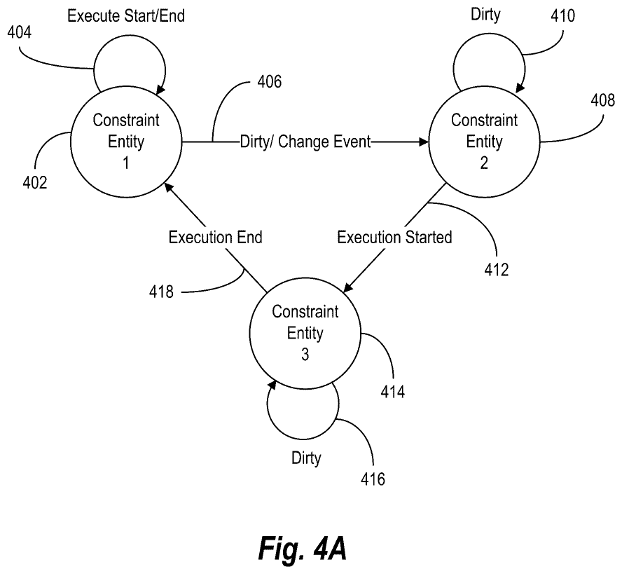

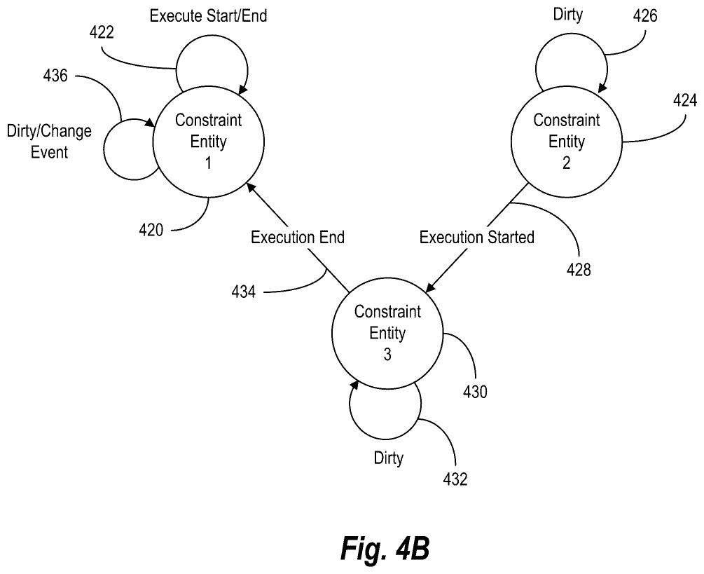

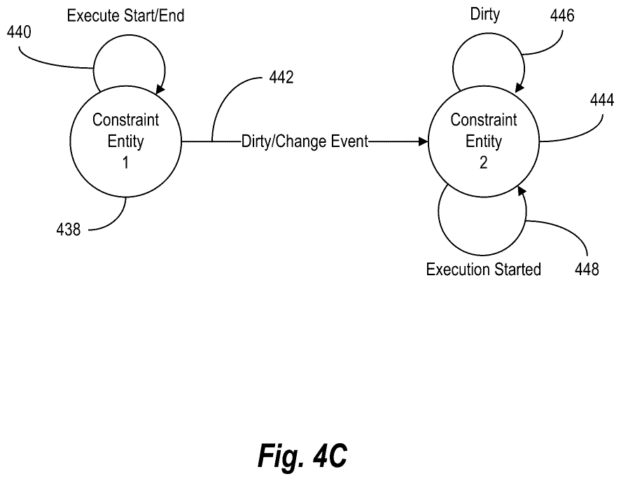

As mentioned, in one or more embodiments, the constraint modification system 106 define constraint states for one or more constraint entities. FIGS. 4A-4C illustrate diagrams of defining and updating constraint states for one or more constraint entities in accordance with one or more embodiments. FIG. 4A illustrates a diagram of updating constraint states according to a clean state. FIG. 4B illustrates a diagram of updating constraint states while one constraint entity is defined as in a hibernate state. FIG. 4C illustrates a diagram of updating constraint states while one constraint entity is defined as in a suspended state.

As illustrated in FIG. 4A, the constraint modification system 106 observes a first constraint entity 402. In particular, the constraint modification system 106 generates an execution order 404 directing the execution of the first constraint entity 402. In one or more embodiments, the constraint modification system 106 executes the first constraint entity 402 by propagating the constraint rules of the first constraint entity 402 across the corresponding set of constraint objects. In some embodiments, the constraint modification system 106 defines the constraint state of the first constraint entity 402 as an executing state. In particular, the constraint modification system 106 applies the executing state to constraint entities in the process of execution (e.g., applying the executing state to the first constraint entity 402 as the first constraint entity 402 is in the process of propagating the execution order 404).

As further illustrated in FIG. 4A, the constraint modification system 106 sends a state change order 406 to a second constraint entity 408. In particular, the constraint modification system 106 sends the state change order 406 to update the state of the second constraint entity 408 based on a change in the state of the first constraint entity 402. In some embodiments, the constraint modification system 106 performs a state change 410 to change the constraint state of the second constraint entity 408 to a dirty state, indicating that the second constraint entity 408 is to be executed upon execution of the first constraint entity 402. In one or more embodiments, the constraint modification system 106 utilizes the dirty state to flag all constraint entities and constraint objects that remain to be modified. In particular, the constraint modification system 106 applies the dirty state to a constraint object to indicate that the constraint object awaits execution.

In one or more embodiments, the constraint modification system 106 sends the state change order 406 to the second constraint entity 408 by determining via an execution sequence (e.g., the execution sequence 312 of FIG. 3) that the first constraint entity 402 is to be executed before the second constraint entity 408. In some embodiments, the constraint modification system 106 defines the execution sequence as an inter-relational directed graph (e.g., the directional graph illustrated in FIG. 4A) among all the constraints (e.g., the first constraint entity 402, the second constraint entity 408, and the third constraint entity 414). In one or more embodiments, the constraint modification system 106 defines the inter-relational graph according to the following formula:
G=(V,E) as a graph containing an edge e=(u, v) with u≠v, with u and v corresponding to a first constraint Cᵢ and a second constraint Cp, with an edge from Cᵢ to C_{jb} if l(Cᵢ, C_{b})=−1.

As further illustrated in FIG. 4A, the constraint modification system 106 sends a state change order 412 to a third constraint entity 414. In particular, the constraint modification system 106 sends the state change order 412 to the third constraint entity 414 to perform a state change 416 to update the third constraint entity 414 to a dirty state. In one or more embodiments, the constraint modification system 106 updates the state of the third constraint entity 414 to a dirty state to indicate that the third constraint entity 414 awaits execution after the execution of the second constraint entity 408.

As further illustrated in FIG. 4A, the constraint modification system 106, upon execution of the third constraint entity 414, generates an execution end sequence 418 to send to the first constraint entity 402. In particular, the constraint modification system 106 sends the execution end sequence 418 to indicate that all constraint entities awaiting execution have been executed. In one or more embodiments, the constraint modification system 106 updates the constraint state of the first constraint entity 402 from an executing state to a clean state upon receiving the execution end sequence 418. In particular, the constraint modification system 106 applies the clean state to constraint objects that have been executed (e.g., indicating that the first constraint entity 402 has just been updated).

As illustrated in FIG. 4B, the constraint modification system 106 determines a hibernate state. As shown, the constraint modification system 106 observes a first constraint entity 420. In particular, the constraint modification system 106 detects a change event 436 that modifies one or more constraint objects corresponding to the first constraint entity 420. In one or more embodiments, the constraint modification system 106 updates the constraint state of the first constraint entity 420 with an execution order 422. In some embodiments, the constraint modification system 106 marks the constraint state of the first constraint entity 420 as an executing state, given that the execution order 422 is currently instructing the first constraint entity 420 to update itself in response to the change event 436.

As further illustrated in FIG. 4B, the constraint modification system 106 additionally observes a second constraint entity 424. In particular, the constraint modification system 106 identifies, via a state change 426, that the second constraint entity 424 is in a dirty state awaiting execution. In one or more embodiments, the constraint modification system 106 updates the state of the second constraint entity 424 from a dirty state to a hibernate state until the first constraint entity 420 is finished executing. In particular, the constraint modification system 106 applies the hibernate state to constraint objects when updating the constraint objects will re-trigger execution of the constraint entity while already under execution. For example, the constraint modification system 106 updates the state of the second constraint entity 424 to the hibernate state to avoid continual triggering of execution while the first constraint entity 420 is propagating the execution across its corresponding set of constraint objects, which could otherwise (e.g., without the hibernate state) trigger an additional execution order based on each alteration to each object within the set of constraint objects. In certain embodiments, the constraint modification system 106 determines whether to define a constraint entity as in a hibernate state according to the following formula for the execution of a constraint entity Cⱼ (e.g., the second constraint entity 424) whose execution is dependent on another constraint entity Cᵢ (e.g., the first constraint entity 420):

$$j ∈ 1 , 2 , … ( i - 1 )$$

indicating that the dependent constraint entity is to be updated to a hibernate state.

As further illustrated in FIG. 4B, the constraint modification system 106 sends an execution notice 428 to a third constraint entity 430. In particular, the constraint modification system 106, based on the execution notice 428, performs a state change 432 to update the state of the third constraint entity 430. In one or more embodiments, the constraint modification system 106 updates the state of the third constraint entity 430 to a dirty state, indicating that it awaits execution upon execution of the second constraint entity 424. Upon execution of the third constraint entity 430, the constraint modification system 106 sends an execution end sequence 434 to the first constraint entity 420 indicating that all constraints have been executed.

As illustrated in FIG. 4C, the constraint modification system 106 determines a suspended state. As shown, the constraint modification system 106 observes a first constraint entity 438. In particular, the constraint modification system 106 generates an execution order 440 indicating the execution of the first constraint entity 438. In one or more embodiments, the constraint modification system 106 updates the constraint state of the first constraint entity 438 to an executing state to indicate that the first constraint entity 438 is currently in the process of execution.

As further illustrated in FIG. 4C, the constraint modification system 106 generates a state change order 442 to notify a second constraint entity 444 to change the constraint state of the second constraint entity 444. In particular, the constraint modification system 106 updates the constraint state of the second constraint entity 444 to a suspend state, where even though the second constraint entity 444 receives a state change 446 and an execution order 448, the constraint modification system 106 does not execute the second constraint entity 444. In particular, the constraint modification system 106 applies the suspend state to indicate that changes to constraint objects does not trigger execution of the constraint entity. For example, the constraint modification system 106 updates the second constraint entity 444 to a suspend state to avoid listening to changes in arts (e.g., alterations to the first constraint entity 438) to allow temporary alterations to constraint objects without propagating the alterations to all constraint objects within the vector design.

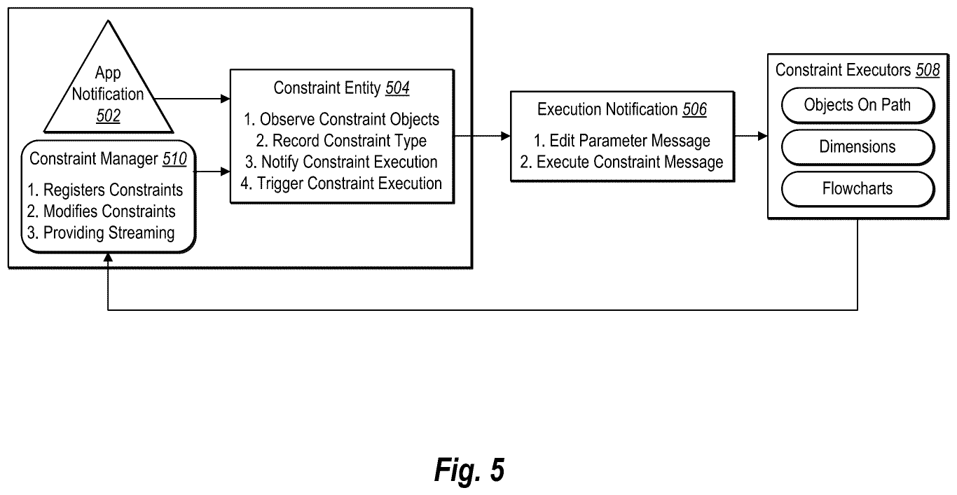

As mentioned, in one or more embodiments, the constraint modification system 106 leverages a constraint executor plugin architecture to manage constraint entities. In particular, the constraint modification system 106 utilizes a constraint execute plugin architecture that is decoupled from specific applications or workflows and adaptable across various applications. FIG. 5 illustrates a diagram of implementing a constraint executor plugin architecture and a constraint manager to manage constraint entities in accordance with one or more embodiments.

As illustrated in FIG. 5, the constraint modification system 106 detects an app notification 502. In particular, the constraint modification system 106 detects the app notification 502 upon one or more objects constrained by a constraint entity being updated (e.g., transformed, deleted, etc.). In one or more embodiments, the constraint modification system 106 observes or determines constraint objects for the constraint entity 504 and detects any updates to the constituent constraint objects.

As further illustrated in FIG. 5, the constraint modification system 106 includes the constraint entity 504. In one or more embodiments, the constraint modification system 106 determines or records a corresponding constraint type (e.g., a path-based relational constraint, a dimensions constraint, a flowcharts constraint) for the constraint entity 504. In some embodiments, the constraint modification system 106 utilizes the constraint entity 504 to generate an execution notification 506. In one or more embodiments, the constraint modification system 106 utilizes the execution notification 506 to instruct a constraint executor from the constraint executors 508 to edit a parameter or to execute a parameter.

As further illustrated in FIG. 5, the constraint modification system 106 utilizes constraint executors 508. In particular, the constraint executors 508 correspond with different constraint types, with a constraint executor programmed to correspond to each constraint type (e.g., objects on path, dimensions, flowchart). In one or more embodiments, the constraint modification system 106 implements the constraint executors 508 as part of a plugin architecture. In some embodiments, the constraint modification system 106 implements the constraint executors 508 as separate plugins. In one or more embodiments, the constraint modification system 106 installs the constraint executors 508 as automatically installed plugins that come packaged as part of a larger design application. In some embodiments, the constraint modification system 106 installs the constraint executors 508 as third-party or custom plugins external to the digital design system 104.

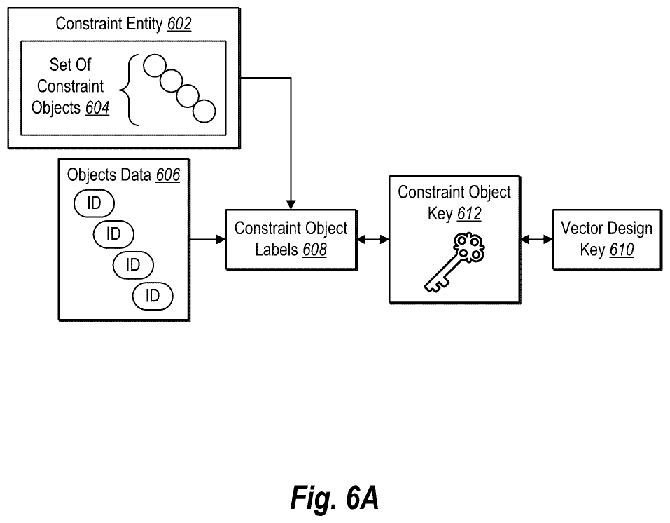

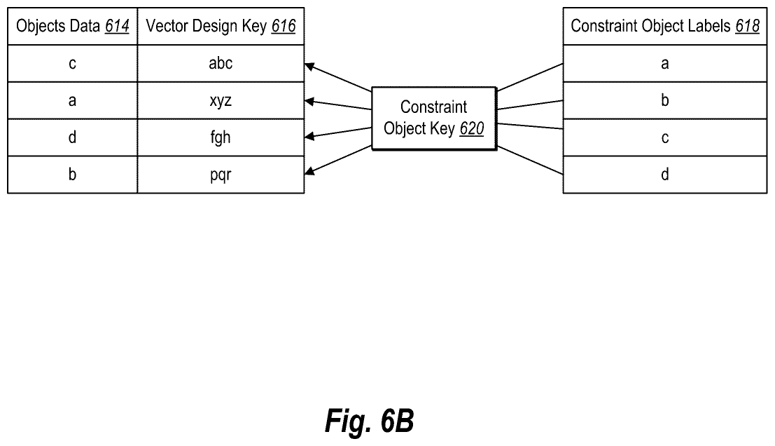

As further illustrated in FIG. 5, the constraint modification system 106 utilizes the constraint executors 508 to notify a constraint manager 510. In particular, the constraint modification system 106 leverages the constraint manager 510 to register and interact with one or more constraint entities (e.g., the constraint entity 504). In one or more embodiments, the constraint modification system 106 utilizes the constraint manager 510 as a single point of communication for other application workflows that interact with the constraint entities (even for multiple constraints and across third-party applications). In one or more embodiments, the constraint modification system 106 utilizes the constraint manager 510 to modify the constraint entity 504 based on receiving a notification from the constraint executors 508. In some embodiments, the constraint modification system 106 utilizes the constraint manager 510 to enable undoing or redoing updating the constraint entity 504 by recording the state of the constraint objects constrained by the constraint entity 504. In some embodiments, the constraint modification system 106 utilizes the constraint manager 510 to stream information associated with constraint entities by saving a constraint entity and enabling it to be recreated in a separate file or client device session. More information on streaming the information of a constraint entity is provided in relation to FIGS. 6A-6B.

As mentioned, in one or more embodiments, the constraint modification system 106 maps constraints to vector designs across multiple client sessions. FIGS. 6A-6B illustrate diagrams of generating a constraint object label to map constraints to vector designs across multiple client sessions in accordance with one or more embodiments. FIG. 6A illustrates a diagram of generating a constraint object key that maps constraint entities to a vector design in accordance with one or more embodiments. FIG. 6B illustrates a diagram of utilizing the constraint object key to map objects in a vector design to a constraint.

As illustrated in FIG. 6A, the constraint modification system 106 identifies a constraint entity 602 with a set of constraint objects 604. In particular, the constraint modification system 106 identifies each object within the set of constraint objects 604 to generate constraint object labels 608. In one or more embodiments, the constraint modification system 106 generates the constraint object labels 608 to map the data relating to the constraint entity 602 from the set of constraint objects 604 to the objects data 606. In some embodiments, the constraint modification system 106 maps the constraint object labels 608 by generating a specific code for each object in the set of constraint objects 604 and mapping the code to a unique key (e.g., the objects data) already present in a vector design. In one or more embodiments, the constraint modification system 106 generates the specific code for the constraint object labels 608 by generating a random character (e.g., Unicode) string. In some embodiments, the constraint modification system 106 maps the constraint object labels 608 to the objects data 606 by accessing a persistent key associated with the objects, such as a PersistentID. In particular, the constraint modification system 106 accesses the persistent key to identify the corresponding objects in a new device session, given that existing ID's (e.g., session ID) correspond to a single device session and are not persistent across multiple device session.

As further illustrated in FIG. 6A, the constraint modification system 106 generates a constraint object key 612 mapping the constraint object labels 608 to a vector design key 610. In particular, the constraint modification system 106 generates the constraint object key 612 to automatically map the constraint object labels 608 onto the objects data 606 in a second client device session (e.g., saving and reloading a file) by searching the vector design key 610 to locate the objects data 606. In one or more embodiments, the constraint modification system 106 utilizes the constraint object key 612 to enable copying and pasting of the constraint entity 602 from one digital design to another by copying the constraint object key 612 to a temporary clipboard, which the constraint modification system 106 utilizes to match the constraint object labels 608 with the vector design key 610 of a second digital design.

As illustrated in FIG. 6B, the constraint modification system 106 accesses a digital design to determine objects data 614 and a vector design key 616. In one or more embodiments, the constraint modification system 106 determines the objects data 614 by accessing the unique key (e.g., a PersistentID) for each object contained within a digital design as part of the object dictionary and streamed as part of the digital design. In some embodiments, the constraint modification system 106 removes the unique key from the object dictionary for future use. In some embodiments, the constraint modification system 106 determines the vector design key 616 by accessing the client device session-specific codes generated for the objects within the vector design.

As further illustrated in FIG. 6B, the constraint modification system 106 utilizes the constraint object key 620 to map the constraint object labels 618 to the vector design key 616 and the objects data 614. In particular, the constraint modification system 106 utilizes the constraint object key by reading the metadata of a digital design (e.g., the digital design including the objects with objects data 614 and the vector design key 616) and identifying a constraint entity (e.g., the constraint entity 602) from a tag associated with the metadata of the digital design (e.g., a tag labeled “Document-Constraints”). In some embodiments, the constraint modification system 106 reads the metadata to determine the constraint type, the constraint data map, and the constraint object labels 618. In one or more embodiments, the constraint modification system 106 leverages the constraint object key 620 to create an un-ordered map defining the constrained objects by identifying the objects that have objects data 614 corresponding to the constraint object key 620 present in the object dictionary, filtering out the objects that are not part of a constraint. In some embodiments, the constraint modification system 106 cross-references the constraint object key 620 with the unique key (e.g., PersistentID) of the objects data 614 associated with a constraint entity to create a mapping between the constraint objects and the constraint entity. Based on this cross-referencing, the constraint modification system 106 maps the objects data 614 to the constraint object labels 618 to enable the utilization of the corresponding constraint entity, creating the necessary observer relationships required for the functioning of the constraint entity.

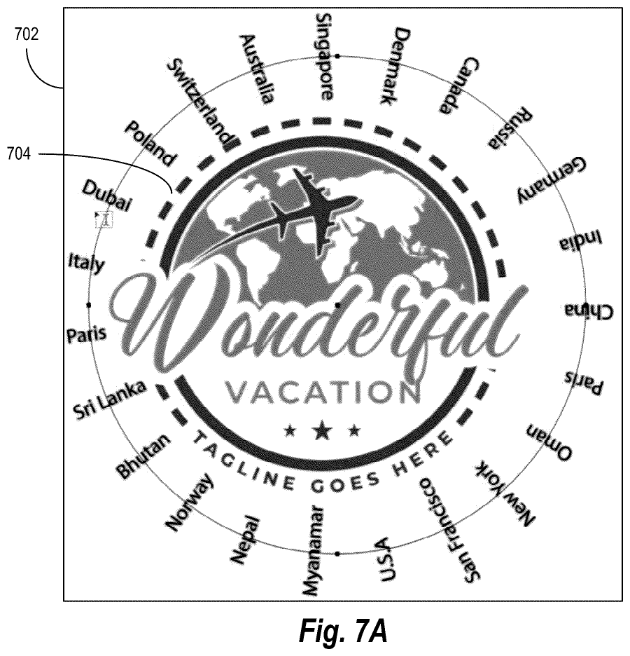

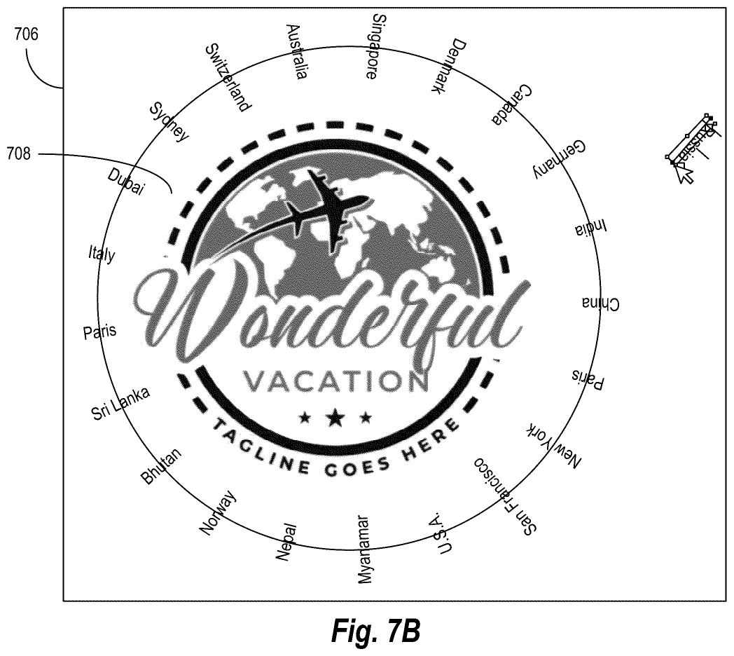

As mentioned, in one or more embodiments, the constraint modification system 106 generates modified vector graphic designs for display on a graphical user interface (GUI). FIGS. 7A-7B illustrate example images of generating a modified vector graphic design by propagating a constraint entity across a set of constraint objects in accordance with one or more embodiments. FIG. 7A illustrates an initial vector graphic design before propagation of a constraint entity displayed on a GUI. FIG. 7B illustrates a modified vector graphic generated by propagating a constraint entity in response to a client device alteration to an object within a set of constraint objects displayed on a GUI.

As illustrated in FIG. 7A, the constraint modification system 106 displays an initial vector graphic design 704 on a GUI 702. In particular, the constraint modification system 106 displays the initial vector graphic design 704 on a client device via the GUI 702. In one or more embodiments, the initial vector graphic design 704 is presented according to a constraint entity (e.g., an info-graphical visual representation of a group of letters revolving a central image).

As illustrated in FIG. 7B, the constraint modification system 106 displays a modified vector graphic design 708 on a GUI 706 following propagation of a constraint entity in response to a client device interaction with an initial vector graphic design (e.g., the initial vector graphic design 704). As shown, the constraint modification system 106 receives an interaction to remove the “Russia” label from the ring of labels in the vector graphic design 708. In response, the constraint modification system 106 generates the modified vector graphic design 708 by propagating a constraint entity in response to a client device interaction (e.g., removing a word from the group of words orbiting a central image). In one or more embodiments, the constraint modification system 106 generates the modified vector graphic design 708 in real time in response to a client device interaction. For example, the constraint modification system 106 automatically modifies the spacing and orientation of the remaining words within the modified vector graphic design 708 in response to the client device interaction removing one of the words within the modified vector graphic design 708.

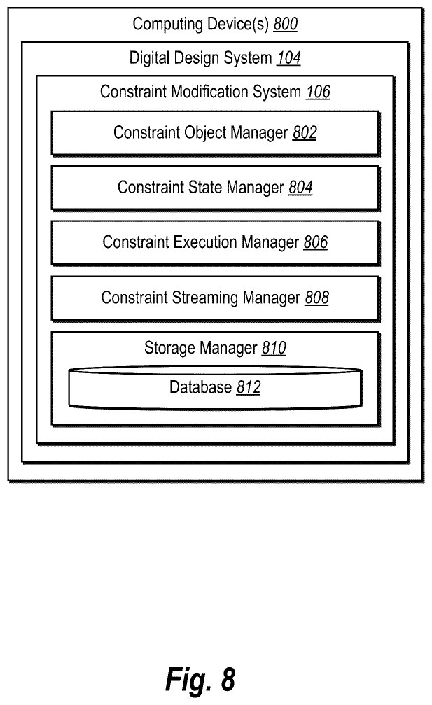

Referring now to FIG. 8, additional detail will now be provided regarding components and capabilities of the constraint modification system 106 on an example computing device(s) 800 (e.g., one or more of the client device 112 and/or the server device(s) 102). As shown in FIG. 8, the constraint modification system 106 includes a constraint object manager, a constraint state manager 804, a constraint execution manager 806, a constraint streaming manager 808, and a storage manager 810.

As mentioned, the constraint modification system 106 includes a constraint object manager 802. In particular, the constraint object manager 802 identifies, modifies, alters, or selects one or more constraint objects (e.g., the set of constraint objects 210). For example, the constraint object manager 802 observes a set of constraint objects and propagates a constraint entity to generate a modified set of constraint objects (e.g., the modified set of constraint objects 222), as described herein.

As mentioned, the constraint modification system 106 includes a constraint state manager 804. In particular, the constraint state manager 804 identifies, modifies, alters, or updates one or more constraint states (e.g., the constraint states describe in relation to FIGS. 4A-4C). For example, as described herein, the constraint state manager 804 identifies a constraint state relative to a constraint entity and updates the constraint state in response to an execution status of the constraint entity.

As mentioned, the constraint modification system 106 includes a constraint execution manager 806. In particular, the constraint execution manager 806 identifies, modifies, alters, or executes one or more constraint entities (e.g., the constraint entity 204). For example, the constraint execution manager 806 updates a constraint entity to propagate the constraint rules across a set of constraint objects in response to a client device interaction, as described herein.

As mentioned, the constraint modification system 106 includes a constraint streaming manager 808. In particular, the constraint streaming manager 808 stores, modifies, alters, or updates constraint entity data across multiple client device sessions by mapping constraint entity data (e.g., by using the constraint object key 612). For example, the constraint streaming manager 808 maps data corresponding to a constraint entity (e.g., the constraint entity 602) to vector graphics objects (e.g., the objects data 606) to a constraint object key in order to access the constraint entity in a second client device session, as described herein.

The constraint modification system 106 further includes a storage manager 810. The storage manager 810 operates in conjunction with the other components of the constraint modification system 106 and includes one or more memory devices such as the database 812 (e.g., the database 110) that stores various data such as constraint entities and other information.

In one or more embodiments, each of the components of the constraint modification system 106 are in communication with one another using any suitable communication technologies. Additionally, the components of the constraint modification system 106 are in communication with one or more other devices including one or more client devices described above. It will be recognized that although the components of the constraint modification system 106 are shown to be separate in FIG. 8, any of the subcomponents may be combined into fewer components, such as into a single component, or divided into more components as may serve a particular implementation. Furthermore, although the components of FIG. 8 are described in connection with the constraint modification system 106, at least some of the components for performing operations in conjunction with the constraint modification system 106 described herein may be implemented on other devices within the environment.

The components of the constraint modification system 106 include software, hardware, or both. For example, the components of the constraint modification system 106 include one or more instructions stored on a computer-readable storage medium and executable by processors of one or more computing devices (e.g., the computing device(s) 800). When executed by the one or more processors, the computer-executable instructions of the constraint modification system 106 cause the computing device(s) 800 to perform the methods described herein. Alternatively, the components of the constraint modification system 106 comprise hardware, such as a special purpose processing device to perform a certain function or group of functions. Additionally, or alternatively, the components of the constraint modification system 106 include a combination of computer-executable instructions and hardware.

Furthermore, the components of the constraint modification system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the constraint modification system 106 may be implemented as part of a stand-alone application on a personal computing device or a mobile device. Alternatively, or additionally, the components of the constraint modification system 106 may be implemented in any application that allows creation and delivery of content to users, including, but not limited to, ADOBE® applications such as PHOTOSHOP®, ILLUSTRATOR®, ADOBE® XD, and CREATIVE CLOUD®. “ADOBE,” “PHOTOSHOP,” “ILLUSTRATOR,” and “CREATIVE CLOUD” are either registered trademarks or trademarks of Adobe Inc. in the United States and/or other countries.

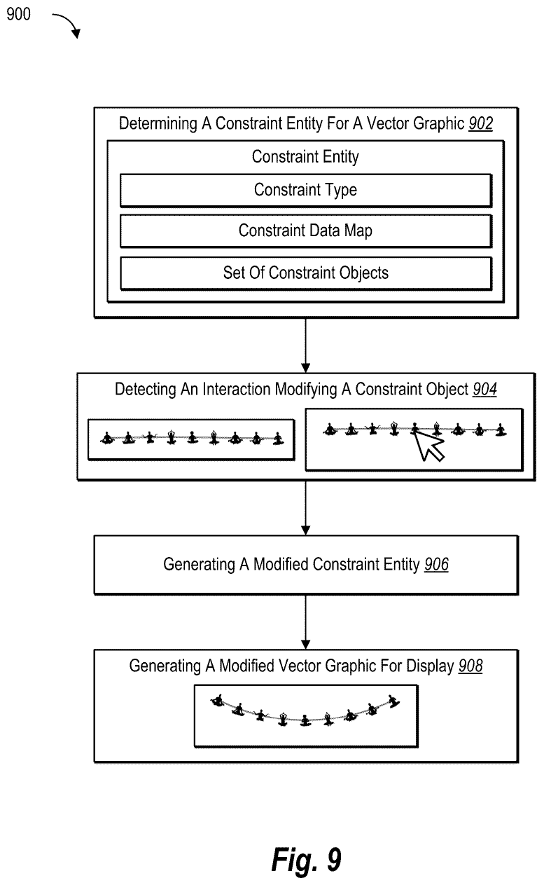

FIGS. 1-8, the corresponding text, and the examples provide a number of different systems, methods, and non-transitory computer readable media for generating a modified vector design graphic by propagating a constraint entity across a set of constraint objects in response to a client device interaction. In addition to the foregoing, embodiments can also be described in terms of flowcharts comprising acts for accomplishing a particular result. For example, FIG. 9 illustrates a flowchart of example sequences or series of acts in accordance with one or more embodiments.

While FIG. 9 illustrates acts according to particular embodiments, alternative embodiments may omit, add to, reorder, and/or modify any of the acts shown in FIG. 9. The acts of FIG. 9 can be performed as part of a method. Alternatively, a non-transitory computer readable medium can comprise instructions that, when executed by one or more processors, cause a computing device to perform the acts of FIG. 9. In still further embodiments, a system can perform the acts of FIG. 9. Additionally, the acts described herein may be repeated or performed in parallel with different instances of the same or other similar acts.

FIG. 9 illustrates an example series of acts 900 for generating a modified vector graphic for display. In particular, the series of acts 900 includes an act 902 of determining a constraint entity for a vector graphic. For example, the act 902 involves determining a constraint entity including a constraint type defining execution logic for the constraint entity as well as a set of constraint objects for a vector graphic. Further, the series of acts 900 includes an act 904 of detecting an interaction modifying a constraint object. For example, the act 904 involves detecting a client device interaction modifying a constraint object within the set of constraint objects defined by the constraint entity. Further, the series of acts 900 includes an act 906 of generating a modified constraint entity. For example, the act 906 involves generating a modified constraint entity in response to the client device interaction modifying the constraint object by updating the constraint entity according to the constraint type to reflect corresponding modifications to one or more related constraint objects within the set of constraint objects. Further, the series of acts 900 includes an act 908 of generating a modified vector graphic for display. For example, the act 908 involves generating a modified vector graphic depicting the modified constraint entity for display on the client device.

In some embodiments, the series of acts 900 includes identifying, for the constraint entity, a constraint data map defining one or more constraint parameters corresponding to the constraint type. The series of acts 900 also includes determining, for the vector graphic, a second constraint entity comprising a second constraint type and a second set of constraint objects. The series of acts 900 also includes determining an execution sequence defining an order of execution for the constraint entity and the second constraint entity. The series of acts 900 also includes generating the modified vector graphic by executing the constraint entity and the second constraint entity according to the execution sequence.

In some embodiments, the series of acts 900 includes performing a comparison between two or more objects within the set of constraint objects and the second set of constraint objects. The series of acts 900 also includes determining, based on the comparison between the two or more objects, a hierarchical relationship between the set of constraint objects and the second set of constraint objects. The series of acts 900 also includes determining the execution sequence based on the hierarchical relationship between the set of constraint objects and the second set of constraint objects.

In some embodiments, the series of acts 900 includes determining that the second set of constraint objects includes at least one constraint object from the set of constraint objects. The series of acts 900 also includes determining the hierarchical relationship between the set of constraint objects and the second set of constraint objects based on the second set of constraint objects including at least one constraint object from the set of constraint objects. The series of acts 900 also includes generating the modified vector graphic by executing the constraint entity and the second constraint entity based on the hierarchical relationship.

In some embodiments, the series of acts 900 includes generating, utilizing a constraint manager, an execution notification instructing a constraint executor to generate the modified constraint entity according to the interaction modifying the constraint object. The series of acts 900 also includes utilizing the constraint executor to generate the modified constraint entity based on the execution notification.

In some embodiments, the series of acts 900 includes determining, from among a set of candidate constraint states, a constraint state defining an execution status of the constraint entity. The series of acts 900 also includes updating the constraint state to a modified constraint state based on the interaction modifying the constraint object. The series of acts 900 also includes generating the modified constraint entity by updating the set of constraint objects defined by the constraint entity according to the modified constraint state.

In some embodiments, the series of acts 900 includes generating, for the set of constraint objects, a set of constraint object labels uniquely identifying constraint objects within the set of constraint objects. The series of acts 900 also includes generating a set of constraint object keys that persists across vector design sessions by mapping the set of constraint object labels to a set of vector design keys. The series of acts 900 also includes providing the set of constraint objects according to the constraint entity for display on a client device by accessing the set of constraint object keys. The series of acts 900 also includes modifying a visual appearance of the vector graphic as displayed on the client device by updating a rendering of the set of constraint objects in interactive fashion responsive to the interaction modifying the constraint object.

In some embodiments, the series of acts 900 includes determining, for a vector graphic, a constraint entity comprising a set of constraint objects and reflecting a constraint state defining an execution status of the constraint entity. The series of acts 900 also includes detecting a modification to a constraint object within the set of constraint objects defined by the constraint entity. The series of acts 900 also includes updating the constraint state to a modified constraint state reflecting a new execution status resulting from the modification to the constraint object. The series of acts 900 also includes generating a modified vector graphic from the vector graphic by updating the set of constraint objects defined by the constraint entity according to the modified constraint state.

In some embodiments, the series of acts 900 includes determining the constraint entity by defining the constraint state as a clean state indicating no modifications to a constraint object within the set of constraint objects defined by the constraint entity. The series of acts 900 also includes updating the constraint state to a modified constraint state by defining the modified constraint state as one of: a dirty state indicating that one or more constraint objects within the set of constraint objects is awaiting execution; a suspended state indicating that the constraint entity does not trigger execution based on changes to the set of constraint objects; or a hibernate state indicating that changes to the set of constraint objects will not re-trigger execution of the constraint entity when already under execution.

In some embodiments, the series of acts 900 includes determining, within the vector graphic, a second constraint entity comprising a second set of constraint objects and reflecting a second constraint state. The series of acts 900 also includes determining an execution order by comparing the constraint entity and the second constraint entity. The series of acts 900 also includes generating the modified vector graphic by updating the set of constraint objects and the second set of constraint objects according to the execution order.

In some embodiments, the series of acts 900 includes generating, utilizing a constraint manager, an execution notification comprising instructions for a constraint executor to generate a modified constraint entity according to the modification to the constraint object. The series of acts 900 also includes updating, utilizing the constraint executor, the set of constraint objects according to the execution notification. The series of acts 900 also includes generating a set of constraint object keys corresponding to the set of constraint objects according to the constraint entity, wherein the set of constraint object keys persists across vector design sessions. The series of acts 900 also includes providing the set of constraint objects for display on a client device by accessing the set of constraint object keys.

In some embodiments, the series of acts 900 includes determining, for a vector graphic depicted within a vector design, a constraint entity comprising a set of constraint objects. The series of acts 900 also includes generating, for a constraint object within the set of constraint objects, a constraint object label uniquely identifying the constraint object. The series of acts 900 also includes generating a constraint object key that persists across vector design sessions by mapping the constraint object label to a vector design key corresponding to the vector design. The series of acts 900 also includes providing the constraint object for display on a client device by accessing the constraint object key.

In some embodiments, the series of acts 900 includes generating the vector graphic in a first vector design session. The series of acts 900 also includes storing, within the first vector design session, the constraint object key in a metadata set associated with the vector graphic. The series of acts 900 also includes providing the constraint object for display in a second vector design session by accessing the constraint object key from the metadata set stored in the first vector design session.

In some embodiments, the series of acts 900 includes saving the constraint entity and the constraint object key to a temporary clipboard. The series of acts 900 also includes applying the constraint entity and the constraint object key to a second display on the client device. The series of acts 900 also includes reproducing the constraint entity and the constraint object key within the second display on the client device.

In some embodiments, the series of acts 900 includes recording, for the constraint entity, a first state defining a placement of the set of constraint objects within the vector graphic. The series of acts 900 also includes generating a modified constraint object from a constraint object within the set of constraint objects. The series of acts 900 also includes updating the first state of the constraint entity to a second state by updating the set of constraint objects according to the modified constraint object. The series of acts 900 also includes transforming, based on a client device interaction indicating a reversal of updating from the first state to the second state, the modified constraint object back to the first state of the constraint entity.

In some embodiments, the series of acts 900 includes determining, for the constraint entity, a constraint state defining an execution status of the constraint entity. The series of acts 900 also includes updating the constraint state to a modified constraint state based on a client device interaction with a constraint object within the set of constraint objects. The series of acts 900 also includes generating a modified vector graphic by updating the set of constraint objects according to the modified constraint state.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

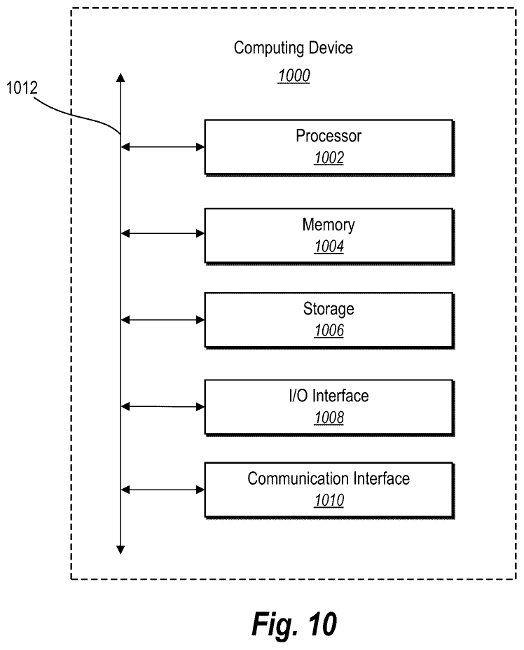

FIG. 10 illustrates, in block diagram form, an example computing device 1000 (e.g., the computing device(s) 800, the client device 112, and/or the server device(s) 102) that may be configured to perform one or more of the processes described above. As shown by FIG. 10, the computing device can comprise a processor(s) 1002, memory 1004, a storage device 1006, an I/O interface 1008, and a communication interface 1010.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them. The computing device 1000 includes memory 1004, which is coupled to the processor(s) 1002. The memory 1004 may be used for storing data, metadata, and programs for execution by the processor(s). The memory 1004 may include one or more of volatile and non-volatile memories. The memory 1004 may be internal or distributed memory. The computing device 1000 includes a storage device 1006 includes storage for storing data or instructions. As an example, and not by way of limitation, storage device 1006 can comprise a non-transitory storage medium described above. The computing device 1000 also includes one or more input or output (“I/O”) devices/interfaces 1008, which are provided to allow a user to provide input to (such as user strokes), receive output from, and otherwise transfer data to and from the computing device 1000. These I/O devices/interfaces 1008 may include a mouse, keypad or a keyboard, a touch screen, camera, optical scanner, network interface, modem, other known I/O devices or a combination of such I/O devices/interfaces 1008.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices (e.g., computing device 1000) or one or more networks. The computing device 1000 can further include a bus 1012. The bus 1012 can comprise hardware, software, or both that couples components of computing device 1000 to each other.

What is claimed is:

1. A computer-implemented method comprising:
determining, for a vector graphic, a constraint entity comprising a constraint type defining execution logic for the constraint entity and further comprising a set of constraint objects of the constraint type;
detecting, from a client device, an interaction modifying a constraint object within the set of constraint objects defined by the constraint entity;
in response to the interaction modifying the constraint object, generating a modified constraint entity by updating, according to the constraint type, the constraint entity to reflect corresponding modifications to one or more related constraint objects within the set of constraint objects; and
generating, for display on the client device, a modified vector graphic depicting the modified constraint entity.

2. The computer-implemented method of claim 1, wherein determining the constraint entity further comprises identifying, for the constraint entity, a constraint data map defining one or more constraint parameters corresponding to the constraint type.

3. The computer-implemented method of claim 1, further comprising:
determining, for the vector graphic, a second constraint entity comprising a second constraint type and a second set of constraint objects;
determining an execution sequence defining an order of execution for the constraint entity and the second constraint entity; and
generating the modified vector graphic by executing the constraint entity and the second constraint entity according to the execution sequence.

4. The computer-implemented method of claim 3, wherein determining the execution sequence comprises:
performing a comparison between two or more objects within the set of constraint objects and the second set of constraint objects;
determining, based on the comparison between the two or more objects, a hierarchical relationship between the set of constraint objects and the second set of constraint objects; and
determining the execution sequence based on the hierarchical relationship between the set of constraint objects and the second set of constraint objects.

5. The computer-implemented method of claim 4, further comprising:
determining that the second set of constraint objects includes at least one constraint object from the set of constraint objects;
determining the hierarchical relationship between the set of constraint objects and the second set of constraint objects based on the second set of constraint objects including at least one constraint object from the set of constraint objects; and
generating the modified vector graphic by executing the constraint entity and the second constraint entity based on the hierarchical relationship.

6. The computer-implemented method of claim 1, wherein generating the modified constraint entity comprises:
generating, utilizing a constraint manager, an execution notification instructing a constraint executor to generate the modified constraint entity according to the interaction modifying the constraint object; and
utilizing the constraint executor to generate the modified constraint entity based on the execution notification.

7. The computer-implemented method of claim 1, further comprising:
determining, from among a set of candidate constraint states, a constraint state defining an execution status of the constraint entity;
updating the constraint state to a modified constraint state based on the interaction modifying the constraint object; and
generating the modified constraint entity by updating the set of constraint objects defined by the constraint entity according to the modified constraint state.

8. The computer-implemented method of claim 1, further comprising:
generating, for the set of constraint objects, a set of constraint object labels uniquely identifying constraint objects within the set of constraint objects;
generating a set of constraint object keys that persists across vector design sessions by mapping the set of constraint object labels to a set of vector design keys; and
providing the set of constraint objects according to the constraint entity for display on a client device by accessing the set of constraint object keys.

9. The computer-implemented method of claim 1, wherein generating the modified vector graphic comprises modifying a visual appearance of the vector graphic as displayed on the client device by updating a rendering of the set of constraint objects in interactive fashion responsive to the interaction modifying the constraint object.

10. A system comprising:
one or more memory devices; and
one or more processors configured to cause the system to:
determine, for a vector graphic, a constraint entity comprising a set of constraint objects and reflecting a constraint state defining an execution status of the constraint entity;
detect a modification to a constraint object within the set of constraint objects defined by the constraint entity;
update the constraint state to a modified constraint state reflecting a new execution status resulting from the modification to the constraint object; and
generate a modified vector graphic from the vector graphic by updating the set of constraint objects defined by the constraint entity according to the modified constraint state.

11. The system of claim 10, wherein the one or more processors are further configured to cause the system to determine the constraint entity by defining the constraint state as a clean state indicating no modifications to a constraint object within the set of constraint objects defined by the constraint entity.

12. The system of claim 10, wherein the one or more processors are further configured to cause the system to update the constraint state to a modified constraint state by defining the modified constraint state as one of:
a dirty state indicating that one or more constraint objects within the set of constraint objects is awaiting execution;
a suspended state indicating that the constraint entity does not trigger execution based on changes to the set of constraint objects; or
a hibernate state indicating that changes to the set of constraint objects will not re-trigger execution of the constraint entity when already under execution.

13. The system of claim 10, wherein the one or more processors are further configured to cause the system to:
determine, within the vector graphic, a second constraint entity comprising a second set of constraint objects and reflecting a second constraint state;
determine an execution order by comparing the constraint entity and the second constraint entity; and
generate the modified vector graphic by updating the set of constraint objects and the second set of constraint objects according to the execution order.

14. The system of claim 13, wherein the one or more processors are further configured to cause the system to generate the modified vector graphic further by:
generating, utilizing a constraint manager, an execution notification comprising instructions for a constraint executor to generate a modified constraint entity according to the modification to the constraint object; and
updating, utilizing the constraint executor, the set of constraint objects according to the execution notification.

15. The system of claim 10, wherein the one or more processors are further configured to cause the system to:
generate a set of constraint object keys corresponding to the set of constraint objects according to the constraint entity, wherein the set of constraint object keys persists across vector design sessions; and
provide the set of constraint objects for display on a client device by accessing the set of constraint object keys.

16. A non-transitory computer readable medium storing executable instructions which, when executed by a processing device, cause the processing device to perform operations comprising:
determining, for a vector graphic depicted within a vector design, a constraint entity comprising a set of constraint objects;
generating, for a constraint object within the set of constraint objects, a constraint object label uniquely identifying the constraint object;
generating a constraint object key that persists across vector design sessions by mapping the constraint object label to a vector design key corresponding to the vector design; and
providing the constraint object for display on a client device by accessing the constraint object key.

17. The non-transitory computer readable medium of claim 16, wherein the operations further comprise:
generating the vector graphic in a first vector design session;
storing, within the first vector design session, the constraint object key in a metadata set associated with the vector graphic; and
providing the constraint object for display in a second vector design session by accessing the constraint object key from the metadata set stored in the first vector design session.

18. The non-transitory computer readable medium of claim 16, wherein the operations further comprise:
saving the constraint entity and the constraint object key to a temporary clipboard;
applying the constraint entity and the constraint object key to a second display on the client device; and
reproducing the constraint entity and the constraint object key within the second display on the client device.

19. The non-transitory computer readable medium of claim 16, wherein the operations further comprise:
recording, for the constraint entity, a first state defining a placement of the set of constraint objects within the vector graphic;
generating a modified constraint object from a constraint object within the set of constraint objects;
updating the first state of the constraint entity to a second state by updating the set of constraint objects according to the modified constraint object; and
transforming, based on a client device interaction indicating a reversal of updating from the first state to the second state, the modified constraint object back to the first state of the constraint entity.

20. The non-transitory computer readable medium of claim 19, wherein the operations further comprise:
determining, for the constraint entity, a constraint state defining an execution status of the constraint entity;
updating the constraint state to a modified constraint state based on a client device interaction with a constraint object within the set of constraint objects; and
generating a modified vector graphic by updating the set of constraint objects according to the modified constraint state.
